(19) United States
(12) Patent Application Publication
(10) Pub. No.: US 2011/0289728 A1
(43) Pub. Date: Dec. 1, 2011

(54) HINGE MECHANISM

(75) Inventors: JIN-XIN WANG, Shenzhen City (CN); JIAN LI, Shenzhen City (CN); SHEN LI, Shenzhen City (CN)

(73) Assignee: HON HAI PRECISION INDUSTRY CO., LTD., Tu-Cheng (TW)

(21) Appl. No.: 12/979,458

(22) Filed: Dec. 28, 2010

(30) Foreign Application Priority Data
May 27, 2010 (CN) 201020205902.6

(51) Int. Cl. E05D 11/08; E05D 7/00

(52) U.S. Cl. 16/337

(57) ABSTRACT

A hinge mechanism includes a connecting member, two pivotal shafts substantially parallel to each other, two main gears, two transmission gears, and a resisting member. The connecting member sleeves on the two pivotal shafts. The two main gears non-rotatably sleeve on the corresponding two pivotal shafts, respectively. The two transmission gears are rotatably positioned between the two main gears and mesh with each other and the two main gears. The resisting member sleeves on the two main pivotal shafts and holds the two main gears and the two transmission gears together with the connecting member.

### BACKGROUND

1. Technical Field

The present disclosure generally relates to hinges, and more particularly to a hinge mechanism applied in an electronic device.

2. Description of Related Art

Many electronic devices include hinged elements. A hinge mechanism often includes a first bracket, a second bracket, and two pivotal shafts to ensure that one part of the electronic device is capable of hinging relative to another. The first bracket and the second bracket are respectively sleeved on the pivotal shafts. The hinge mechanism further includes other elements, such as a plurality of friction members, resilient members, and fasteners sleeved on the pivotal shafts to provide an axial force between the elements.

In use, the first bracket, when rotated, rotates one of the pivotal shafts relative to the other. Therefore, the two parts of the electronic device are capable of rotating relative to each other.

However, to open or close the electronic device, continuous force must be applied on one part of the electronic device, and may take a relatively long time to open or close.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of one embodiment of a hinge mechanism.

FIG. 2 is an exploded, isometric view of the hinge mechanism of FIG. 1.

### DETAILED DESCRIPTION

The hinge mechanism as described in the embodiment as presented herein may be applied in any electronic device having two or more hinged parts, such as notebook computers, LCD monitors, and DVD (digital video disc) players.

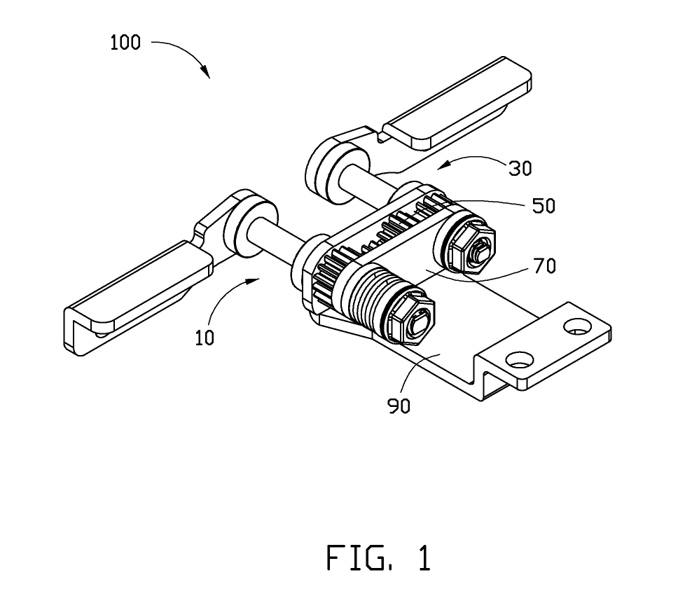

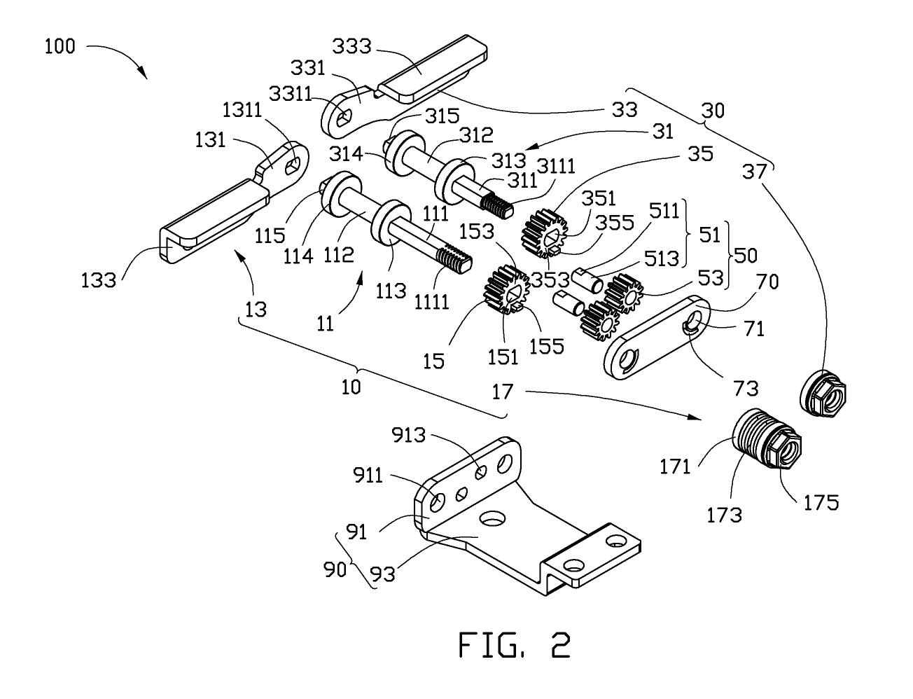

Referring to FIGS. 1 and 2, a hinge mechanism 100 includes a first rotary assembly 10, a second rotary assembly 30 substantially parallel to the first rotary assembly 10, a transmission assembly 50, a resisting member 70, and a connecting member 90. The transmission assembly 50 is assembled between the first rotary assembly 10 and the second rotary assembly 30, and is held by the resisting member 70 and the connecting member 90. The resisting member 70 and the connecting member 90 both sleeve on the first and second rotary assemblies 10, 30, such that the transmission assembly 50 is sandwiched between the first and second rotary assemblies 10, 30.

The first rotary assembly 10 includes a pivotal shaft 11, a bracket 13, a main gear 15, and a shaft sleeve 17. The pivotal shaft 11 includes a non-circular shaft portion 111, a substantially circular shaft portion 112, a first flange 113, a second flange 114, and a fixing portion 115. The non-circular shaft portion 111 and the fixing portion 115 coaxially connect with the substantially circular shaft portion 112, and are respectively positioned at two ends of the substantially circular shaft portion 112. The non-circular shaft portion 111 defines a threaded portion 1111 at a distal end thereof. The first flange 113 is substantially annular and extends from a joint of the non-circular shaft portion 111 and the substantially circular shaft portion 112. The second flange 114 is substantially parallel to the first flange 113 and formed at a joint of the fixing portion 115 and the circular shaft portion 112 away from the non-circular shaft portion 111. The fixing portion 115 is substantially rectangular block shaped in the illustrated embodiment.

The bracket 13 is fixed to the fixing portion 115 of the pivotal shaft 11 and assembled with a cover or main body of an electronic device in use (not shown). The bracket 13 includes a pivotal portion 131 and a connecting portion 133. The pivotal portion 131 defines a fixing hole 1311 corresponding to the fixing portion 115 of the pivotal shaft 11.

The main gear 15 defines a non-circular hole 151. The main gear 15 sleeves on the non-circular shaft portion 111 of the pivotal shaft 11 via the non-circular hole 151. The main gear 15 further includes an end surface 153 and a protrusion 155 formed on the end surface 153 and positioned adjacent to the non-circular hole 151.

The shaft sleeve 17 is fixed on the threaded portion 1111 of the non-circular shaft portion 111. In the illustrated embodiment, the shaft sleeve 17 includes a friction member 171, a resilient member 173, and a fastener 15. The resilient member 173 is sandwiched between the friction member 171 and the fastener 15.

The second rotary assembly 30 has substantially the same structure as the first rotary assembly 10. The second rotary assembly 30 also includes a pivotal shaft 31, a bracket 33, a main gear 35, and a shaft sleeve 37. The pivotal shaft 31 includes a non-circular shaft portion 311, a substantially circular shaft portion 312, a first flange 313, a second flange 314, and a fixing portion 315. The non-circular shaft portion 311 defines a threaded portion 3111 at a distal end thereof. The bracket 33 includes a pivotal portion 331 and a connecting portion 333. The pivotal portion 331 defines a fixing hole 3311 corresponding to the fixing portion 315 of the pivotal shaft 31. The main gear 35 defines a non-circular hole 351 therethrough and includes an end surface 353 and a protrusion 355 formed on the end surface 353 and positioned adjacent to the non-circular hole 351. The second rotation assembly 30 is similar to the first rotation assembly 10 but without the friction member 14 and the resilient members 15. Alternatively, the second rotation assembly 30 may have the same structure as the first rotation assembly 10. In the illustrated embodiment, the shaft sleeve 37 of the second rotary assembly 30 is similar to the shaft sleeve 17 of the first rotary assembly 10, but without the resilient member 173.

The transmission assembly 50 is assembled between the first rotary assembly 10 and the second rotary assembly 30, and includes two rotary shafts 51 and two transmission gears 53. The two rotary shafts 51 each include a non-circular shaft end 511 and a substantially circular shaft end 513. The non-circular shaft end of the rotary shaft 51 is fixed to the connecting member 90. The two transmission gears 53 respectively rotatably sleeve on the corresponding circular shaft end 513 of the two rotary shafts 51 and mesh with each other.

The resisting member 70 is a substantially bar-shaped plate, and defines two pivotal holes 71 positioned adjacent to two ends of the resisting member 70. Two arcuate limiting slots 73 are defined in one surface of the resisting member 70 and are respectively positioned adjacent to the two pivotal holes 71. In the illustrated embodiment, the central angle of the arcuate limiting slots 73 is preferably about 90 to about 100°. It is understood that the central angle of the arcuate limiting slots 73 can be about 30°, about 60°, about 120°, or similar.

The connecting member 90 is a substantially U-shaped plate sleeving on the two pivotal shafts 11, 31, and includes a side plate 91 and a bottom plate 93 extending from one edge of the side plate 91. Two shaft holes 911 are defined through the side plate 91 and positioned adjacent to two ends of the side plate 91, corresponding to the two pivotal holes 71 of the resisting member 70. Two non-circular shaft holes 913 are defined through the side plate 91 corresponding to the two rotary shafts 51, and positioned between the two shaft holes 911 adjacent to two sides of the side plate 91, such that one non-circular shaft hole 913 is positioned adjacent to the bottom plate 93, and the other non-circular shaft hole 913 is away from the bottom plate 93.

During assembly of the hinge mechanism 100, the non-circular shaft ends 511 of the two rotary shafts 51 are respectively received in the two non-circular shaft holes 913 of the side plate 91. The two transmission gears 53 are respectively sleeved on the circular shaft ends 513 of the two rotary shafts 51 and rotatably mesh with each other. The two pivotal shafts 11, 31 are substantially parallel and assembled to the connecting member 90, the non-circular shaft portions 111, 311 of the pivotal shafts 11, 31 respectively pass through the two shaft holes 911 of the side plate 91 with the first flanges 113, 313 abutting the side plate 91. The two main gears 15, 35 are respectively sleeved on the non-circular shaft portions 111, 311 of the pivotal shafts 11, 31 and mesh with the corresponding two transmission gears 53. The resisting member 70 sleeves on the two non-circular shaft portions 111, 311 of the pivotal shafts 11, 31, with the two non-circular shaft portions 111, 311 passing through the two pivotal holes 71 of the resisting member 70. The two protrusions 155, 355 of the two main gears 15, 35 are respectively slidably received within the corresponding two arcuate limiting slots 73 of the resisting member 70. The two shaft sleeves 17 are respectively sleeved and fixed on the threaded portion 1111 of the non-circular shaft portion 111 and the threaded portion 3111 of the noncircular shaft portion 311, such that the two main gears 15, 35 and the two transmission gears 53 are sandwiched between the side plate 91 and the resisting member 70. The two brackets 13, 33 are respectively fixed to the fixing portions 115, 315 of the pivotal shafts 11, 31, with the two fixing portions 115, 315 respectively passing through the corresponding fixing holes 1311 of the brackets 13, 33 by interference fit to finish the assembly of the hinge mechanism 100.

In use, the hinge mechanism 100 is applied to an electronic device (not shown), the two connecting portions 133, 333 of the two brackets 13, 33 are respectively fixed to a cover and a main body of the electronic device. When an external force is exerted on the cover of the electronic device to drive the first rotary assembly 10, the pivotal shaft 11 is rotated together with the cover. The main gear 15 rotates together with the pivotal shaft 11 and transmits the rotational moment generated therefrom to the main gear 35 of the second rotary assembly 30 via the two transmission gears 53, such that the main gear 35 is rotated together with the pivotal shaft 31 in an opposite direction relative to the main gear 15. Meanwhile, the rotational moment is transmitted to the bracket 33 of the second rotary assembly 30 by the pivotal shaft 31. Therefore, the cover and the main body of the electronic device opens or closes quickly and easily by means of the two transmission gears 53.

It is to be understood, however, that even through numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A hinge mechanism, comprising:
two pivotal shafts substantially parallel to each other;
a connecting member sleeved on the two pivotal shafts;
two main gears non-rotatably sleeved on the two pivotal shafts, respectively;
two transmission gears rotatably positioned between the two main gears and meshing with each other and the two main gears; and
a resisting member sleeved on the two main pivotal shafts and holding the two main gears and the two transmission gears together with the connecting member.

2. The hinge mechanism of claim 1, wherein each of the main gears comprises an end surface and a protrusion formed on the end surface, the resisting member defines two arcuate limiting slots and two pivotal holes corresponding to the two pivotal shafts, and the protrusions of the two main gears respectively slidably engage into the two arcuate limiting slots of the resisting member.

3. The hinge mechanism of claim 2, wherein the hinge mechanism further comprises two rotary shafts substantially parallel and fixed to the connecting member, and the two transmission gears respectively sleeve on the two rotary shafts.

4. The hinge mechanism of claim 3, wherein each pivotal shaft comprises a non-circular shaft portion, a substantially circular shaft portion coaxially connecting with the non-circular shaft portion, and a first flange formed at a joint of the non-circular shaft portion and the circular shaft portion; each main gear defines a non-circular hole corresponding to the non-circular shaft portion of the pivotal shaft such that the main gear is non-rotatably sleeved on the non-circular shaft portion of the pivotal shaft.

5. The hinge mechanism of claim 4, wherein the connecting member comprises a side plate and a bottom plate extending from the side plate, the side plate defines two shaft holes, the non-circular shaft portions of the two pivotal shafts respectively pass through the two shaft holes, and the first flanges of the two pivotal shafts abut against the side plate; the two main gears together with the two transmission gears are sandwiched between the side plate and the resisting member.

6. The hinge mechanism of claim 5, wherein the side plate further defines two non-circular shaft holes corresponding to the two rotary shafts and positioned between the two shaft holes; each of the two rotary shafts has a non-circular shaft end fixed to the non-circular shaft hole of the side plate, and an opposite circular shaft end; the two transmission gears respectively sleeve on the circular shaft ends of the two rotary shaft.

7. The hinge mechanism of claim 6, wherein the two non-circular shaft holes are respectively located adjacent to two sides of the side plate such that one non-circular shaft hole is positioned adjacent to the bottom plate, and the other non-circular shaft hole is away from the bottom plate.

8. The hinge mechanism of claim 5, wherein each pivotal shaft further comprises a fixing portion coaxially formed at the distal end of the circular shaft portion, and a second flange formed at the joint of the circular shaft portion and the fixing portion; the hinge mechanism further comprises two brackets respectively fixed to the fixing portions of the two pivotal shafts.

9. The hinge mechanism of claim 8, wherein each pivotal shaft defines a threaded portion at a distal end of the non-circular shaft portion, and the hinge mechanism further comprises two shaft sleeves respectively engaging with the threaded portions of the two pivotal shafts.

10. A hinge mechanism, comprising:
a connecting member defining a first shaft hole and a second shaft hole;
a first rotary assembly comprising a first pivotal shaft rotatably assembled to the first shaft hole of the connecting member, and a first main gear non-rotatably sleeved on the first pivotal shaft;
a second rotary assembly substantially parallel and assembled to the connecting member relative to the first rotary assembly, the second rotary assembly comprising a second pivotal shaft passing through the second shaft hole of the connecting member, and a second main gear non-rotatably sleeved on the second pivotal shaft and substantially parallel to and apart from the first main gear; and
a transmission assembly assembled between the first rotary assembly and the second rotary assembly, the transmission assembly comprising two transmission gears rotatably assembled to the connecting member and meshing with each other and the first and second main gears such that the first and second rotary assemblies are rotatably assembled with each other via the transmission assembly.

11. The hinge mechanism of claim 10, wherein the first and second main gears each comprises an end surface and a protrusion formed on the end surface, the hinge mechanism further comprises a resisting member sleeved on the first and second pivotal shafts, and the resisting member defines two arcuate limiting slots respectively slidably engaging with the two protrusions of the two main gears.

12. The hinge mechanism of claim 10, wherein the first and second pivotal shafts each comprises a non-circular shaft portion and a substantially circular shaft portion coaxially connecting with the non-circular shaft portion; the first and second main gears each defines a non-circular hole corresponding to the non-circular shaft portion of the pivotal shaft such that the main gear is non-rotatably sleeved on the non-circular shaft portion of the pivotal shaft.

13. The hinge mechanism of claim 12, wherein the first and second pivotal shafts each further comprises a fixing portion coaxially formed at the distal end of the circular shaft portion; the hinge mechanism further comprises two brackets respectively fixed to the fixing portions of the two pivotal shafts.

14. The hinge mechanism of claim 13, wherein the first and second pivotal shafts each defines a threaded portion at the distal end of the non-circular shaft portion, and the hinge mechanism further comprises two shaft sleeves respectively engaging with the threaded portions of the two pivotal shafts.
